(19) United States
(12) Patent Application Publication
(10) Pub. No.: US 2018/0076952 A1
(43) Pub. Date: Mar. 15, 2018

(54) IMAGE PROCESSING APPARATUS, CONTROL SYSTEM, AND NON-TRANSITORY COMPUTER READABLE STORAGE MEDIUM

(71) Applicant: FUJI XEROX CO., LTD., Tokyo (JP)

(72) Inventors: Masayuki KONO, Kanagawa (JP); Kenichiro TAKANO, Kanagawa (JP); Harushi TAKIGAWA, Kanagawa (JP); Rinya SADAKUNI, Kanagawa (JP); Kazuya TORIKAI, Kanagawa (JP); Hirokazu TAKAHASHI, Kanagawa (JP)

(73) Assignee: FUJI XEROX CO., LTD., Tokyo (JP)

(21) Appl. No.: 15/491,044

(22) Filed: Apr. 19, 2017

(30) Foreign Application Priority Data
Sep. 14, 2016 (JP) 2016-179399

(51) Int. Cl. H04L 9/08; H04N 1/44; G06F 3/12; H04N 1/00; H04L 9/14; H04L 9/32; G06F 21/60

(52) U.S. Cl. CPC H04L 9/083; H04N 1/4413; G06F 3/1222; G06F 3/1238; G06F 3/1285; H04N 2201/0094; H04L 9/0894; H04L 9/14; H04L 9/3226; G06F 21/608; H04N 1/00411

(57) ABSTRACT

An image processing apparatus includes:
a processing unit that executes a process related to an image;
an acquisition unit that acquires a first key and a second key including a restriction condition;
a transition unit that transitions from a first operation mode to a second operation mode when the first key is acquired;
a counting unit that counts usage of the processing unit; and
a restricting unit that restricts execution of the process by the processing unit in the second operation mode according to a relationship between the counted usage and the restriction condition included in the acquired second key.

### CROSS-REFERENCE TO RELATED APPLICATIONS

This application is based on and claims priority under 35 USC 119 from Japanese Patent Application No. 2016-179399 filed Sep. 14, 2016.

### BACKGROUND

### Technical Field

The present invention relates to an image processing apparatus, a control system, and a non-transitory computer readable storage medium.

### SUMMARY

According to an aspect of the invention, an image processing apparatus includes:

a processing unit that executes a process related to an image;

an acquisition unit that acquires a first key and a second key including a restriction condition;

a transition unit that transitions from a first operation mode to a second operation mode when the first key is acquired;

a counting unit that counts usage of the processing unit; and

a restricting unit that restricts execution of the process by the processing unit in the second operation mode according to a relationship between the counted usage and the restriction condition included in the acquired second key.

### BRIEF DESCRIPTION OF THE DRAWINGS

Exemplary embodiments of the present invention will be described in detail based on the following figures, wherein:

FIG. 1 is a view illustrating an example of a control system;

FIG. 2 is a view illustrating an example of a hardware configuration of an issuing device;

FIG. 3 is a view illustrating an example of a hardware configuration of an issuing device;

FIG. 4 is a view illustrating an example of a hardware configuration of an image processing apparatus;

FIG. 5 is a view illustrating an example of a functional configuration of a control system;

FIG. 6 is a view illustrating an example of an issuing table;

FIG. 7 is a view illustrating an example of a ratio parameter;

FIG. 8 is a view illustrating an example of an issuing table;

FIG. 9 is a view illustrating an example of an issuing table;

FIG. 10 is a sequence chart illustrating the operation of the control system at the time of new prepaid contract;

FIG. 11 is a sequence chart illustrating the operation of the control system at the time of prepaid renewal;

FIG. 12 is a sequence chart illustrating the operation of the control system at the time of cancellation of prepaid contract;

FIG. 13 is a view illustrating an example of a method of restriction based on a type of toner according to a modification;

FIG. 14 is a view illustrating an example of a ratio parameter according to a modification; and

FIG. 15 is a view illustrating an example of a control system according to a modification.

### DETAILED DESCRIPTION

### Configuration

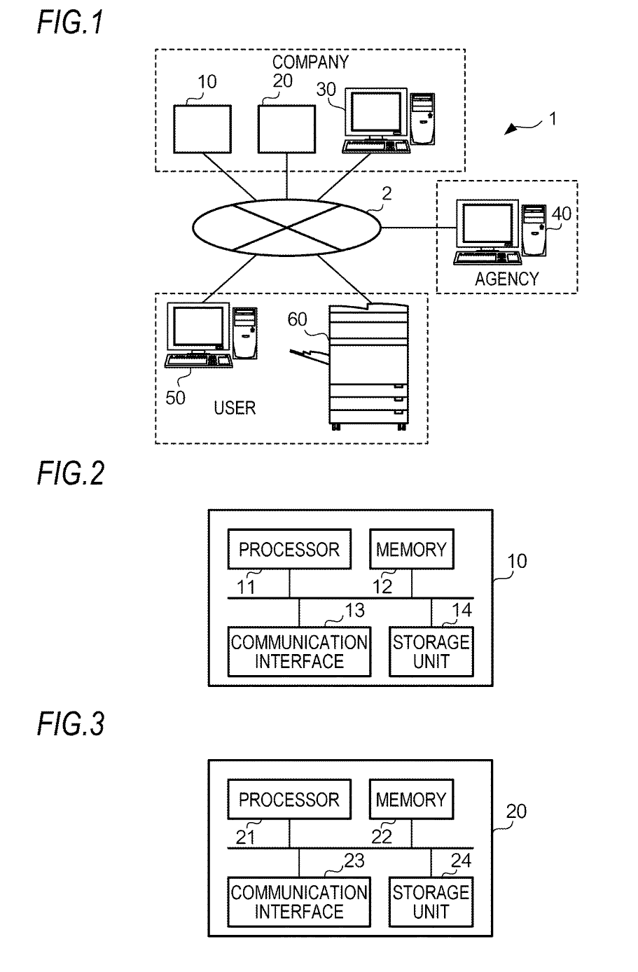

FIG. 1 is a view illustrating an example of a control system 1 according to an exemplary embodiment. In the control system 1, a company that manufactures and sells an image processing apparatus 60 provides the image processing apparatus 60 to a user through an agency. The user may purchase or rent the image processing apparatus 60. When purchasing the image processing apparatus 60, the user uses the image processing apparatus 60 without being charged according to the usage. Meanwhile, when renting the image processing apparatus 60, the user is charged according to the usage of the image processing apparatus 60.

This charging may include a postpaid method and a prepaid method. The postpaid method refers to a method of paying later a fee corresponding to the usage of the image processing apparatus 60. When the postpaid method is used, a worker of an agency has to visit a place where the image processing apparatus 60 is installed, and check the usage of the image processing apparatus 60. Meanwhile, the prepaid method refers to a method by which use of the image processing apparatus 60 is permitted only by the usage corresponding to a fee paid in advance. When the prepaid method is used, the operation of the image processing apparatus is restricted according to the usage. The control system 1 is a system for realizing this prepaid method.

As illustrated in FIG. 1, the control system 1 includes issuing devices 10 and 20, terminal devices 30, 40, and 50, and an image processing apparatus 60. The issuing devices 10 and 20, the terminal devices 30, 40, and 50, and the image processing apparatus 60 are interconnected via a communication line 2. The communication line 2 may include the Internet, a private network such as a local area network (LAN), and a public switched telephone network. It should be noted that the communication line 2 is not limited thereto. The communication line 2 may be another communication network. One terminal device 40, one terminal device 50, and one image processing apparatus 60 are illustrated in FIG. 1. It should be noted that the number of each of the terminal device 40, the terminal device 50, and the image processing apparatus 60 may be two or more.

Both of the issuing devices 10 and 20 are computers such as servers. The issuing devices 10 and 20 are managed by the above-mentioned company. The terminal device 30 is a computer such as a personal computer. The terminal device 30 is used by the person in charge of this company to input and output information on the issuing devices 10 and 20.

The terminal device 40 is a computer such as a personal computer. The terminal device 40 is used by the person in charge of the agency. The person in charge of the agency uses the terminal device 40 to perform various procedures related to a prepaid type rental contract (hereinafter referred to as a “prepaid contract”) for the company.

The terminal device 50 is a computer such as a mobile terminal, a tablet terminal, a personal computer or the like. The terminal device 50 is used by a user. The user uses the terminal device 50 to perform various procedures related to the prepaid contract for the agency. The image processing apparatus 60 has plural functions such as a print function, a scan function, a facsimile function, a copy function and the like. The image processing apparatus 60 is used by the user.

FIG. 2 is a view illustrating an example of a hardware configuration of the issuing device 10. The issuing device 10 includes a processor 11, a memory 12, a communication interface 13, and a storage unit 14. The processor 11 executes various processes according to a program stored in the memory 12. As the processor 11, for example, a central processing unit (CPU) may be used. The memory 12 stores a program to be executed by the processor 11. As the memory 12, for example, a random access memory (RAM) and a read only memory (ROM) may be used. The communication interface 13 is connected to the communication line 2 and performs a communication via the communication line 2. The storage unit 14 stores various data and programs. As the storage unit 14, for example, a hard disk drive may be used.

FIG. 3 is a view illustrating an example of a hardware configuration of the issuing device 20. The issuing device 20 includes a processor 21, a memory 22, a communication interface 23, and a storage unit 24. The processor 21 executes various processes according to a program stored in the memory 22. As the processor 21, for example, a CPU may be used. The memory 22 stores a program to be executed by the processor 21. As the memory 22, for example, a RAM and a ROM may be used. The communication interface 23 is connected to the communication line 2 and performs a communication via the communication line 2. The storage unit 24 stores various data and programs. As the storage unit 24, for example, a hard disk drive may be used.

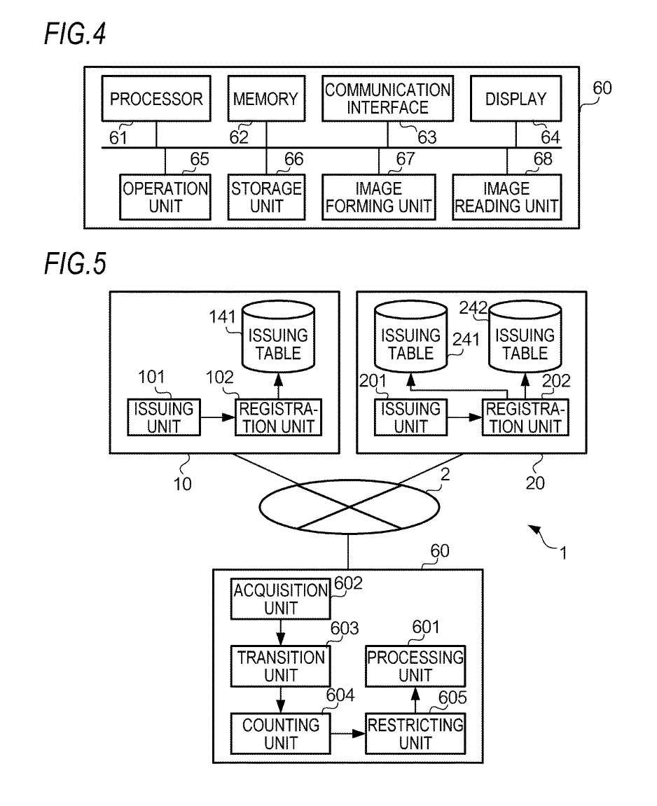

FIG. 4 is a view illustrating an example of a hardware configuration of the image processing apparatus 60. The image processing apparatus 60 includes a processor 61, a memory 62, a communication interface 63, a display 64, an operation unit 65, a storage unit 66, an image forming unit 67, and an image reading unit 68. The processor 61 executes various processes according to a program stored in the memory 62. As the processor 61, for example, a CPU may be used. The memory 62 stores a program to be executed by the processor 61. As the memory 62, for example, a RAM and a ROM may be used. The communication interface 63 is connected to the communication line 2 and performs a communication via the communication line 2. This communication may include facsimile communication.

The display 64 displays various types of information. As the display 64, for example, a liquid crystal display may be used. The operation unit 65 is used to operate the image processing apparatus 60. As the operation unit 65, for example, a touch panel and operation buttons may be used. The storage unit 66 stores various data and programs. As the storage unit 66, for example, a hard disk drive may be used. The image forming unit 67 forms an image on a medium such as a sheet. As the image forming unit 67, for example, an electrophotographic printer may be used. The image reading unit 68 optically reads an image of an original document. As the image reading unit 68, for example, an image scanner may be used.

The image processing apparatus 60 has a prepaid mode and a normal mode. The prepaid mode is an operation mode applied when using the image processing apparatus 60 under a prepaid contract. In the prepaid mode, use of the image processing apparatus 60 is permitted by an available usage corresponding to a prepayment. In this manner, the prepaid mode has a limit in usage. Meanwhile, the normal mode is an operation mode applied, for example, when the user purchases the image processing apparatus 60. In the normal mode, there is no limit on the usage, unlike the prepaid mode.

FIG. 5 is a view illustrating an example of a functional configuration of the control system 1. The terminal devices 30, 40, and 50 are not illustrated in FIG. 5. The issuing device 10 functions as an issuing unit 101 and a registration unit 102. These functions are implemented, for example, when the processor 11 executes a program stored in the memory 12.

The issuing unit 101 (an example of a first issuing unit) issues a transition key (an example of a first key) in response to a prepaid contract being made between a user and an agency. As used herein, the term “issuing” refers to generating and outputting a transition key. The transfer key is issued to, for example, the agency and is provided from the agency to the user. The transition key is used to transition the operation mode of the image processing apparatus 60 from the normal mode to the prepaid mode. The transition key is a software key generated according to a predetermined algorithm. As the transition key, for example, a string of symbols such as numerals or alphabets may be used.

The registration unit 102 registers the issue information of the transition key in an issuing table 141. The issuing table 141 is stored in advance in the storage unit 14.

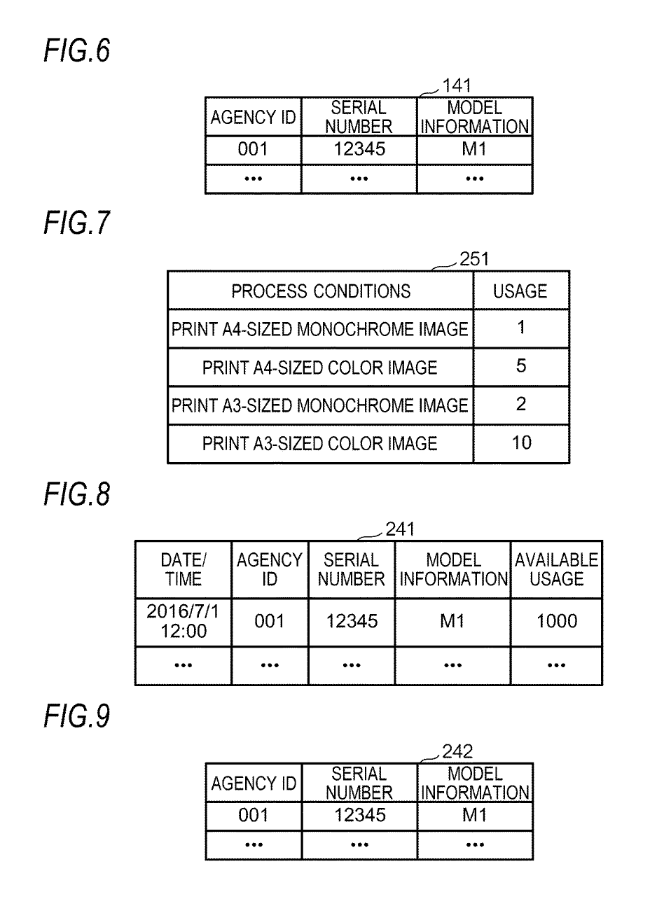

FIG. 6 is a view illustrating an example of the issuing table 141. In the issuing table 141, an agency ID, a serial number, and model information are stored in association with each other. The agency ID is information for identifying the agency which serves as an issuing destination of the transition key. The serial number is information for identifying the image processing apparatus 60 in which the issuing key is used. The model information is information indicating a model of the image processing apparatus 60.

Referring back to FIG. 5, the issuing device 20 functions as an issuing unit 201 and a registration unit 202. These functions are implemented, for example, when the processor 21 executes a program stored in the memory 22.

The issuing unit 201 (an example of a second issuing unit) issues a prepaid key (an example of a second key) after the transition key is issued. The prepaid key is issued to, for example, the agency and is provided from the agency to the user. The prepaid key is a software key generated according to a predetermined algorithm. As the prepaid key, for example, a string of symbols such as numerals or alphabets may be used. The prepaid key may include restriction conditions of image processing and may be therefore used to restrict the image processing in the prepaid mode.

The prepaid key may include an available usage. The available usage is an upper limit usage by which the image processing apparatus 60 is permitted to be used by the user. The available usage decreases according to the usage of the image processing apparatus 60. This usage is counted based on, for example, the number of prints, the number of scans, or the number of times of transmission/reception of facsimile data. The number of prints may include not only the number of printed images but also the number of copied mages and the number of sheets on which facsimile data is printed.

A ratio parameter 251 (an example of a ratio) may be included in the prepaid key. The ratio parameter 251 has a ratio of plural usages predetermined for plural process conditions. The process conditions include, for example, a print condition set for printing, a scan condition set for scanning, a transfer condition set for facsimile, or a copy condition set for copying. The print condition includes, for example, the size and color of an image. Further, the print condition may include whether to perform double-sided printing, the color of a toner to be used, or the type of post-processing.

FIG. 7 is a view illustrating an example of the ratio parameter 251. In this example, when one sheet of A4-sized monochrome image is printed, the usage is 1. When one sheet of A4-sized color image is printed, the usage is 5. When one sheet of A3-sized monochrome image is printed, the usage is 2. When one sheet of A3-sized color image is printed, the usage is 10. That is, the usage that the printing of A4-sized color image requires is five times the usage that the printing of A4-sized monochrome image requires. The usage that the printing of A3-sized monochrome image requires is twice the usage that the printing of A4-sized monochrome image requires. The usage that the printing of A3-sized color image requires is ten times the usage that the printing of A4-sized monochrome image requires.

Referring back to FIG. 5, when the user cancels the prepaid contract between the user and the agent and purchases the image processing apparatus 60, the issuing unit 201 issues a prepaid key including a release key (an example of a third key). The release key is issued to, for example, the agency and provided from the agency to the user. The release key is used to transition the operation mode of the image processing apparatus 60 from the prepaid mode to the normal mode. The release key is a software key generated according to a predetermined algorithm. As the release key, for example, a string of symbols such as numerals or alphabets may be used.

The registration unit 202 registers issuance history information of the prepaid key in the issuing table 241. When the prepaid key including the release key is issued, the registration unit 202 registers issuance information of the release key in the issuing table 242. The issuing tables 241 and 242 are stored in advance in the storage unit 24.

FIG. 8 is a view illustrating an example of the issuing table 241. Date/time, an agency ID, a serial number, model information, and an available usage are stored in the issuing table 241 in association. The date/time is date/time when the prepaid key is issued. The agency ID is information for identifying an agency serving as an issuing destination of the prepaid key. The serial number is information for identifying an image processing apparatus 60 in which the prepaid key is used. The model information is information indicating a model of the image processing apparatus 60. The available usage is an available usage included in the prepaid key.

FIG. 9 is a view illustrating an example of the issuing table 242. An agency ID, a serial number, and model information are stored in the issuing table 242 in association with each other. The agency ID is information for identifying an agency serving as an issuing destination of the release key. The serial number is information for identifying an image processing apparatus 60 in which the release key is used. The model information is information indicating a model of the image processing apparatus 60.

Referring back to FIG. 5, the issuing devices 10 and 20 make restrictions on access. The issuing device 10 permits an access by the terminal device 30, but refuses an access by other devices. For example, the terminal device 40 may not access the issuing device 10. The issuing device 20 permits an access from the terminal device 30 and the terminal device 40 used by the agency to which the transition key is issued, but refuses an access from other devices. For example, when a transition key is issued to an agency, an agency ID of this agency is stored in the issuing table 141. In this case, the issuing device 20 permits an access by the terminal device 40 of this agency. Here, since the transition key is actually transmitted to the terminal device 40 used by the agency, it may be said that the transition key is issued to the terminal device 40.

The image processing apparatus 60 functions as a processing unit 601, an acquisition unit 602, a transition unit 603, a counting unit 604, and a restricting unit 605. The processing unit 601 is implemented by the communication interface 63 and the image forming unit 67 or the image reading unit 68 under control of the processor 61. The acquisition unit 602, the transition unit 603, the counting unit 604, and the restricting unit 605 are implemented, for example, when the processor 61 executes a program stored in the memory 62.

The processing unit 601 performs a process related to an image. This process includes, for example, a printing process, a scanning process, a facsimile process or a copying process. The processing unit 601 may perform this process according to set process conditions. The process conditions include, for example, a print condition set for printing, a scan condition set for scanning, a transfer condition set for facsimile, or a copy condition set for copying.

The acquisition unit 602 acquires the transition key and the prepaid key. The user inputs the transition key and the prepaid key provided by the agency into the image processing apparatus 60. The acquisition unit 602 decodes the issuing key and the prepaid key input by the user, acquires the transition key and the prepaid key when the decoding is successful, and does not acquire the transition key and the prepaid key when the decoding fails. Further, when an available usage is included in the prepaid key, the acquisition unit 602 acquires the available usage. Further, when a ratio parameter 251 or a release key is included in the prepaid key, the acquisition unit 602 acquires the ratio parameter 251 or the release key.

When the transition key is acquired by the acquisition unit 602, the transition unit 603 transitions from the normal mode (an example of the first operation mode) to the prepaid mode (an example of the second operation mode). When the release key is acquired by the acquisition unit 602, the transition unit 603 transitions from the prepaid mode to the normal mode.

The counting unit 604 counts the usage of the processing unit 601. When the processing unit 601 executes a process according to the set process conditions, the counting unit 604 counts the usage corresponding to this process according to a ratio corresponding to the set process conditions of the ratio parameter 251 acquired by the acquisition unit 602.

For example, the counting unit 604 subtracts the usage of the processing unit 601 from an available usage acquired by the acquisition unit 602. The sum of usages of the processing unit 601 is obtained from a difference between the initial available acquired by the acquisition unit 602 and a decreased available usage. In the example illustrated in FIG. 7, when one sheet of A4-sized monochrome image is printed, the usage of the processing unit 601 is 1. In this case, the counting unit 604 decreases the available usage by one. When the sum of usages of the processing unit 601 reaches the available usage, the remaining available usage becomes zero.

As another example, the counting unit 604 may count the sum of usages of the processing unit 601. In this case, when the sum of usages of the processing unit 601 reaches the available usage acquired by the acquisition unit 602, the remaining available usage becomes zero.

In the prepaid mode, the restricting unit 605 restricts execution of the process by the processing unit 601 according to the relationship between the usage counted by the counting unit 604 and the restriction conditions acquired by the acquisition unit 602. For example, when the available usage is acquired by the acquisition unit 602, and the usage counted by the counting unit 604 is equal to or less than the available usage, the restricting unit 605 permits the processing unit 601 to execute the process. Meanwhile, when the usage counted by the counting unit 604 exceeds the available usage, the restricting unit 605 prohibits the process by the processing unit 601 from being executed. At this time, the restricting unit 605 may prohibit execution of all or a part of processes by the processing unit 601. For example, the restricting unit 605 may prohibit execution of all of the printing process, the coping process, the scanning process, and the facsimile process or may prohibit only the execution of the printing process. In addition, in the normal mode, the restricting unit 605 permits the processing unit 601 to execute a process without restriction on the usage.

### Operation New Prepaid Contract

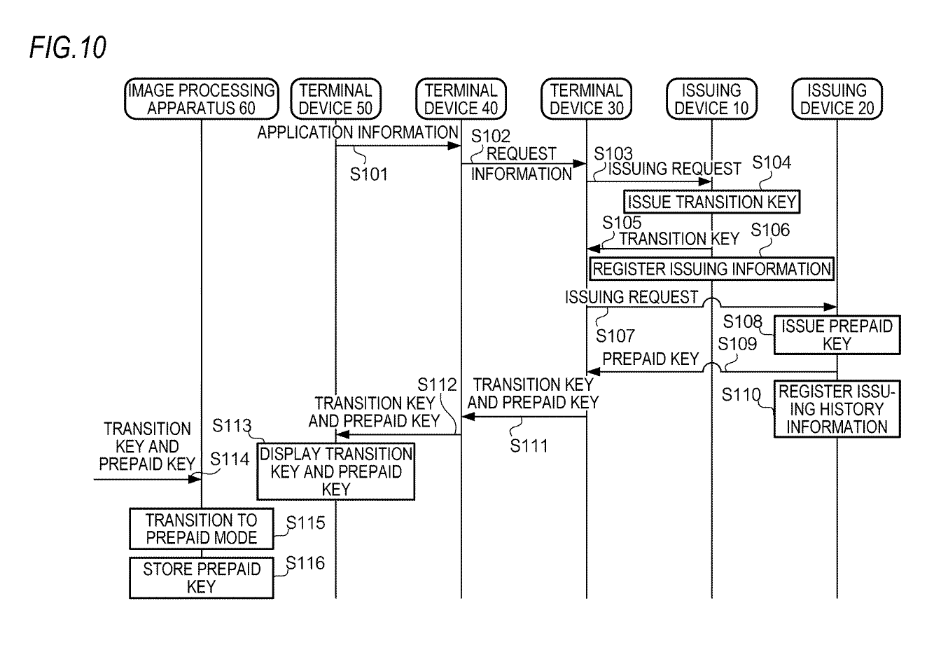

FIG. 10 is a sequence chart illustrating the operation of the control system 1 at the time of new prepaid contract. Here, it is assumed that a user makes a new prepaid contract with an agency. In addition, it is assumed that a prepaid type rental basic contract has been concluded between a company and the agency in advance. With this basic contract, an agency ID “001” and a password are assigned to the agency.

In step S101, the user uses the terminal device 50 to apply for a new prepaid contract to the agency. Specifically, the user operates the terminal device 50 to input application information. The terminal device 50 transmits the input application information to the terminal device 40.

In step S102, upon receiving the application information, the agency makes a new prepaid contract with the user. Subsequently, the person in charge of the agency uses the terminal device 40 to request the company to issue a transition key. Specifically, the person in charge of the agency operates the terminal device 40 to input request information. The request information includes a serial number “12345” and model information “M1” of the image processing apparatus 60 to be rented to the user, and the agency ID “001” assigned to the agency. The terminal device 40 transmits the input request information to the terminal device 30.

In step S103, upon receiving the request information, the person in charge of the company uses the terminal device 30 to make a request to issue a transition key. Specifically, the person in charge of the company operates the terminal device 30 to input an issuing request. The issuing request includes the serial number “12345,” the model information “M1,” and the agency ID “001” included in the received request information. The terminal device 30 transmits the input issuing request to the issuing device 10.

In step S104, upon receiving the issuing request, the issuing device 10 issues a transition key. Specifically, the issuing unit 101 generates a transition key. This transition key is encrypted by a predetermined algorithm.

In step S105, the issuing unit 101 transmits the transition key to the terminal device 30.

In step S106, the registration unit 102 registers the issuing information of the transition key in the issuing table 141. In this example, as illustrated in FIG. 6, the agency ID “001,” the serial number “12345” and the model information “M1” included in the issuing request are stored in the issuing table 141.

Referring back to FIG. 10, when the transition key is issued in step S107, the person in charge of the company uses the terminal device 30 to make a request to issue a prepaid key. Specifically, the person in charge of the company operates the terminal device 30 to input an issuing request. The issuing request includes an available usage, in addition to the serial number “12345,” the model information “M1” and the agency ID “001” included in the request information received from the terminal device 40. This available usage is usage according to a fee of the new prepaid contract prepaid by the user to the agency. In this example, it is assumed that the available is 1000. The terminal device 30 transmits the input issuing request to the issuing device 20.

In step S108, upon receiving the issuing request, the issuing device 20 issues a prepaid key. Specifically, the issuing unit 201 generates a prepaid key. This prepaid key includes an available usage and a ratio parameter 251. This prepaid key is encrypted by a predetermined algorithm.

In step S109, the issuing unit 201 transmits the prepaid key to the terminal device 30.

In step S110, the registration unit 202 registers issuing history information of the prepaid key in the issuing table 241. In this example, as illustrated in FIG. 8, issuing date/time “2016/7/1 12:00” of the prepaid key, the agency ID “001,” the serial number “12345” and the model information “M1” included in the issuing request and the available usage “1000” included in the prepaid key are stored in the issuing table 241.

Referring back to FIG. 10, in step S111, the terminal device 30 transmits the transition key received from the issuing device 10 and the prepaid key received from the issuing device 20 to the terminal device 40.

In step S112, upon receiving the transition key and the prepaid key, the terminal device 40 transmits the transition key and the prepaid key to the terminal device 50.

In step S113, upon receiving the transition key and the prepaid key, the terminal device 50 displays the transition key and the prepaid key on a display.

In step S114, the user inputs the displayed transition key and prepaid key to the image processing apparatus 60. Specifically, the user operates the operation unit 65 to input the transition key and the prepaid key by. The acquisition unit 602 decodes the input issuing key and prepaid key, acquires the transition key and prepaid key when the decoding is successful, and does not acquire the transition key and prepaid key when the decoding fails.

When the transition key is acquired in step S115, the transition unit 603 transitions the operation mode of the image processing apparatus 60 from the normal mode to the prepaid mode.

In step S116, the prepaid key is stored in the storage unit 66. Further, the available usage and the ratio parameter 251 included in the prepaid key are stored in the storage unit 66. In this example, the initial available usage is 1000.

Here, it is assumed that usage according to the number of prints is counted and execution of a printing process by the image forming unit 67 is restricted according to the relationship between the counted usage and an available usage. After operating the operation unit 65 to set a printing condition, the user instructs the execution of the printing process. The counting unit 604 counted the usage corresponding to this printing process according to the ratio parameter 251 stored in the storage unit 66. For example, it is assumed that an A4-sized monochrome image is set as the printing condition, and the number of prints is one. In this case, in the example illustrated in FIG. 7, 1 is counted as the usage according to this printing process.

The restricting unit 605 determines whether or not the available usage stored in the storage unit 66 is equal to or more than the counted usage. When the available usable is equal to or more than the usage, this means that the sum of usages of the processing unit 601 is equal to or less than the available usage. In this case, the restricting unit 605 permits the image forming unit 67 to execute the printing process. Meanwhile, when the available usage is less than the usage, this means that the sum of usages of the processing unit 601 exceeds the available usage. In this case, the restricting unit 605 prohibits the image forming unit 67 from executing the printing process.

When the printing process is executed, the counting unit 604 subtracts the usage from the available usage stored in the storage unit 66. In this manner, every time the user performs the printing process, the available usage stored in the storage unit 66 is reduced. As a result, the printing process is performed by the user until the available usage stored in the storage unit 66 becomes zero. Meanwhile, when the available usage stored in the storage unit 66 becomes zero, the printing process may not be thereafter performed.

### Prepaid Renewal

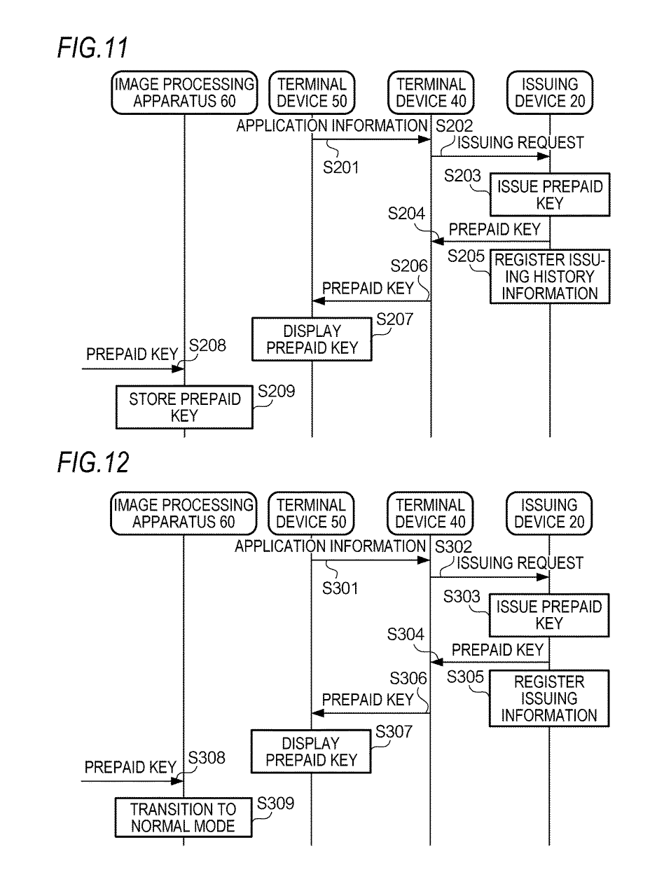

FIG. 11 is a sequence chart illustrating the operation of the control system 1 at the time of prepaid renewal. As described above, in the prepaid mode, when the available usage becomes zero, the subsequent printing process may not be performed. In this case, this operation is performed in order to enable the printing process to be executed again.

In step S201, the user uses the terminal device 50 to apply for a prepaid renewal to the agency. Specifically, the user operates the terminal device 50 to input application information. The application information includes the serial number “12345,” the model information “M1” and the available usage of the image processing apparatus 60. This available usage is usage according to a fee of the prepaid renewal prepaid by the user to the agency. Here, it is assumed that the available usage is 1000. The terminal device 50 transmits the input application information to the terminal device 40.

In step S202, upon receiving the application information, the agency makes a prepaid renewal with the user. Subsequently, the person in charge of the agency uses the terminal device 40 to request the issuing device 20 to issue a prepaid key. Specifically, the person in charge of the agency operates the terminal device 40 to input an issuing request. This issuing request includes the agency ID “001,” in addition to the serial number “12345,” the model information “M1” and the available usage “1000” included in the received application information. The terminal device 40 transmits the input issuing request to the issuing device 20.

As illustrated in FIG. 6, the agency ID “001” included in the issuing request is stored in the issuing table 141. This indicates that a transition key has been issued to the agency. In this case, the issuing device 20 permits an access from the terminal device 40.

Referring back to FIG. 11, in step S203, upon receiving the issuing request, the issuing device 20 issues a prepaid key. Specifically, the issuing unit 201 generates a prepaid key. This prepaid key includes the available usage “1000.” This prepaid key is encrypted by a predetermined algorithm.

In step S204, the issuing unit 201 transmits the prepaid key to the terminal device 40.

In step S205, the registration unit 202 registers issuing history information of the prepaid key in the issuing table 241. In this example, as in the above-described step S110, the date and time when the prepaid key was issued, the agency ID “001,” the serial number “12345” and the model information “M1” included in the issuing request, and the available usage “1000” included in the prepaid key are stored in the issuing table 241.

In step S206, upon receiving the prepaid key, the terminal device 40 transmits this prepaid key to the terminal device 50.

In step S207, upon receiving the prepaid key, the terminal device 50 displays this prepaid key on a display.

In step S208, the user inputs the displayed prepaid key to the image processing apparatus 60. Specifically, the user operates the operation unit 65 to input the prepaid key. The acquisition unit 602 decodes the input prepaid key, acquires the prepaid key when the decoding is successful, and does not acquire the prepaid key when the decoding fails.

In step S209, the prepaid key is stored in the storage unit 66. Further, the available usage included in the prepaid key is stored in the storage unit 66.

When a new available usage is stored in the storage unit 66, the restricting unit 605 permits the image forming unit 67 to execute a printing process until this available usage becomes zero. As a result, the printing process is performed again by the user.

### Cancellation of Prepaid Contract

FIG. 12 is a sequence chart illustrating the operation of the control system 1 at the time of cancellation of the prepaid contract. This cancellation of the prepaid contract is performed, for example, when the user purchases the image processing apparatus 60.

In step S301, the user uses the terminal device 50 to make an application for cancellation of the prepaid contract to the agency. Specifically, the user operates the terminal device 50 to input application information. This application information includes the serial number “12345” and the model information “M1” of the image processing apparatus 60. The terminal device 50 transmits the input application information to the terminal device 40.

In step S302, upon receiving the application information, the agency cancels the prepaid contract with the user. Subsequently, the person in charge of the agency uses the terminal device 40 to request the company issue a release key. Specifically, the person in charge of the agency operates the terminal device 40 to input an issuing request. This issuing request includes the agency ID “001” assigned to the agency, in addition to the serial number “12345” and the model information “M1” included in the received application information. The terminal device 40 transmits the input issuing request to the issuing device 20.

As illustrated in FIG. 6, the agency ID “001” included in the issuing request is stored in the issuing table 141. This indicates that a transition key has been issued to the agency. In this case, the issuing device 20 permits an access from the terminal device 40.

Referring back to FIG. 12, in step S303, the issuing device 20 issues a prepaid key including the release key. Specifically, the issuing unit 201 generates a prepaid key including the release key. This prepaid key is encrypted by a predetermined algorithm.

In step S304, the issuing unit 201 transmits the prepaid key to the terminal device 40.

In step S305, the registration unit 202 stores the issuing information of the release key in the issuing table 242. In this example, as illustrated in FIG. 9, the agency ID “001,” the serial number “12345” and the model information “M1” included in the issuing request are stored in the issuing table 242.

Referring back to FIG. 12, in step S306, upon receiving the prepaid key, the terminal device 40 transmits this prepaid key to the terminal device 50.

In step S307, upon receiving the prepaid key, the terminal device 50 displays this prepaid key on a display.

In step S308, the user inputs the displayed prepaid key to the image processing apparatus 60. Specifically, the user operates the operation unit 65 to input the prepaid key. The acquisition unit 602 decodes the input prepaid key, acquires the prepaid key when the decoding is successful, and does not acquire the prepaid key when the decoding fails. In addition, the acquisition unit 602 acquires the release key included in the prepaid key.

In step S309, when the prepaid key including the release key is acquired, the transition unit 603 transitions the operation mode of the image processing apparatus 60 from the prepaid mode to the normal mode. After transitioning to the normal mode, the restricting unit 605 permits the image forming unit 67 to execute a printing process irrespective of the usage. As a result, the user may perform the printing process without limit on the usage. In addition, when transitioning to the normal mode, the available usage and the ratio parameter 251 stored in the storage unit 66 may be deleted.

According to the above-described embodiment, the prepaid mode in which execution of a process is restricted according to the usage and the normal mode without such restriction are implemented on the single image processing apparatus 60. Accordingly, when the image processing apparatus 60 is rented in a postpaid manner or purchased, the same image processing apparatus 60 may be used. Therefore, for example, it is not necessary for the company to separately manufacture an image processing apparatus 60 for postpaid type rental and an image processing apparatus 60 to be purchased. Further, for example, when the user cancels the postpaid contract and purchases the image processing apparatus 60, the user may continue using the rented image processing apparatus 60 without replacing it.

Further, in the above-described embodiment, the available usage and the ratio parameter 251 is encrypted. This may prevent the available usage and the ratio parameter 251 from being tampered in an unauthorized manner. Furthermore, in the above-described embodiment, the issuing table 241 manages the issuing history of legitimate prepaid keys. Therefore, for example, even when illegal tampering of the available usage is performed, by comparing the available usage stored in the issuing table 241 with the available usage stored in the storage unit 66, the illegal tampering may be detected.

Further, in the above-described embodiment, the release key is encrypted. This may prevent illegal transition from the prepaid mode to the normal mode. Furthermore, in the above-described embodiment, the issuing information of an authorized release key is managed by the issuing table 242. Therefore, for example, even when illegal transition to the normal mode is made, by confirming whether or the issuing information of the release key is stored in the issuing table 242, the illegal transition may be detected.

Further, according to the control system 1, the rental of a prepaid type image processing apparatus 60 is implemented. In the case of renting a postpaid type image processing apparatus 60, in order to confirm the usage of the image processing apparatus 60, an agency worker needs to visit an installation place of the image processing apparatus 60. Therefore, labor costs of the worker occur. Further, since a fee is paid after using the image processing apparatus 60, there is a possibility that damage may be caused due to an unpaid fee. In the case where the image processing apparatus 60 is rented in a prepaid manner, such a disadvantage does not occur.

### Modifications

The above-described embodiment is an example of the present invention. This exemplary embodiment may be modified as follows. In addition, the following modifications may be used in combination.

### Modification 1

In the above-described embodiment, the prepaid key is transmitted from the issuing device 20 to the terminal device 40. However, the prepaid key may be transmitted from the issuing device 20 to the terminal device 30. In this case, upon receiving the prepaid key from the issuing device 20, the terminal device 30 transmits the received prepaid key to the terminal device 40. In addition, the issuing device 20 refuses an access from a device other than the terminal device 30.

In another example, the prepaid key may be transmitted directly from the issuing device 20 to the terminal device 50 or the image processing apparatus 60. In this case, the application information and the issuing request include an address of the terminal device 50 or the image processing apparatus 60. This address is, for example, an e-mail address when the prepaid key is transmitted by e-mail.

### Modification 2

In the above-described embodiment, when the image forming unit 67 uses a toner to perform an image printing process (an example of an image forming process), the execution of the printing process by the image forming unit 67 may be restricted according to the type of toner. The type of toner is, for example, a type corresponding to the operation mode of the image processing apparatus 60 or a type corresponding to a manufacturer of the toner.

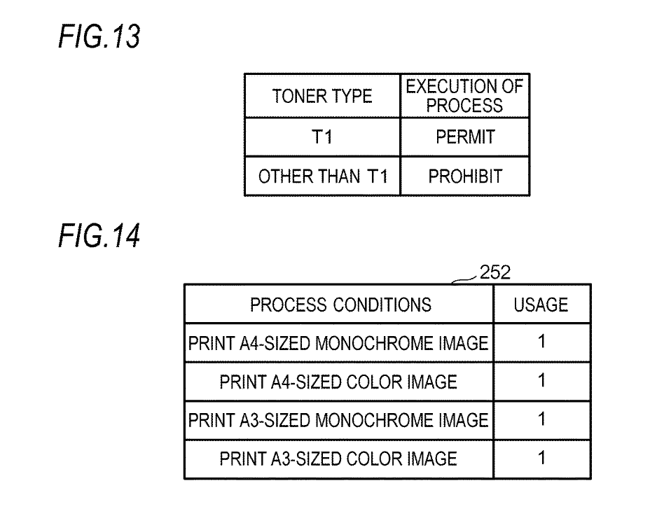

FIG. 13 is a view illustrating an example of a method of restriction based on the type of toner according to this modification. In this case, the prepaid key includes a specific toner type. The specific toner type may be one or more types. Here, it is assumed that the specific toner type is “T1.” The acquisition unit 602 acquires a prepaid key including the toner type. A toner cartridge is attached to the image processing apparatus 60. This toner cartridge has a memory. The type of a toner accommodated in the toner cartridge is stored in advance in the memory. When the toner type stored in this memory is different from the type “T1” acquired by the acquisition unit 602, the restricting unit 605 prohibits the image forming unit 67 from executing a printing process. This may prevent a toner other than the specific type toner from being used.

### Modification 3

In the above-described embodiment, different ratio parameters may be provided for different agencies or different users. For example, a prepaid key issued to an agency A includes a ratio parameter 251 illustrated in FIG. 7. Meanwhile, a prepaid key issued to an agency B may include a ratio parameter 252 illustrated in FIG. 14. When this ratio parameter 252 is used, the usage is 1 even when one sheet of image of any size and color is printed. Which ratio parameter is provided to which agency or user is determined in advance by, for example, a prepaid type rental basic contract.

### Modification 4

In the above-described embodiment, the person in charge of the agency may use the terminal device 40 to view the issuing history of the prepaid key of the agency. For example, the person in charge of the agency operates the terminal device 40 to make a request for viewing the issuing history of the prepaid key. In accordance with this operation, the terminal device 40 transmits to the issuing device 20 a request to acquire the issuing history information of the prepaid key. The acquiring request includes the agency ID “001” assigned to the agency. In addition, this acquiring request may include a password assigned to the agency.

Upon receiving this acquiring request, the issuing device 20 generates the issuing history information of the prepaid key issued to the agency. More specifically, a record including the agency ID “001” is extracted from the issuing table 241. The issuing history information including the extracted records is generated. The issuing device 20 transmits the generated issuing history information to the terminal device 40. Upon receiving the issuing history information from the issuing device 20, the terminal device 40 displays the received issuing history information on a display. This issuing history information is viewed by the person in charge of the agency.

### Modification 5

In the above-described embodiment, when the user rents plural image processing apparatuses 60, a management device that manages these image processing apparatuses 60 may be provided.

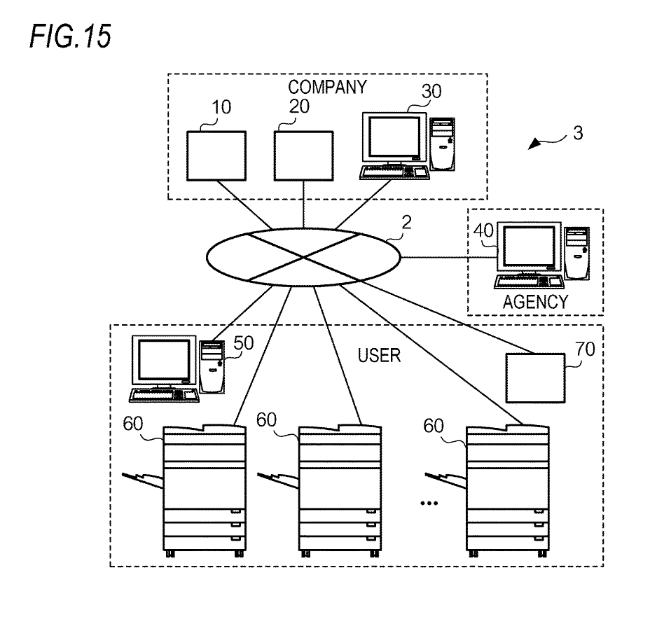

FIG. 15 is a view illustrating an example of a control system 3 according to modification 5. The control system 3 includes plural image processing apparatuses 60 and a management device 70, in addition to the issuing devices 10 and 20 and the terminal devices 30, 40 and 50 illustrated in FIG. 1.

The management device 70 is a computer such as a server. The management device 70 may be configured so that available usages and ratio parameters 251 stored in the plural image processing apparatuses 60 may be viewed together. Specifically, the management device 70 transmits to the plural image processing apparatuses 60 a request to acquire the available usages and the ratio parameters 251. In response to this acquiring request, each of the plural image processing apparatuses 60 transmits the available usage and the ratio parameter 251 stored in the storage unit 66 to the management device 70. Upon receiving the available usages and the ratio parameters 251 from the plural image processing apparatuses 60, the management device 70 displays a list of received available usages and ratio parameters 251 on a display.

In another example, the management device 70 may intensively manage the available usages of the plural image processing apparatuses 60. In this case, the management device 70 has the same function as the above-described acquisition unit 602. The following process performed by the management device 70 is implemented, for example, by a processor executing a program stored in a memory.

In this case, the user inputs a transition key and a prepaid key to the management device 70. As another example, the transition key and the prepaid key may be transmitted directly from the issuing device 20 to the management device 70. In this case, the transition key and the prepaid key received from the issuing device 20 are input to the management device 70. The management device 70 decodes the input transition key and prepaid key, acquires the transition key and prepaid key when the decoding is successful, and does not acquire the transition key and prepaid key when the decoding fails.

Upon acquiring the transition key, the management device 70 transmits the transition key to the plural image processing apparatuses 60. Upon receiving the transition key from the management device 70, each of the plural image processing apparatuses 60 transitions the operation mode from the normal mode to the prepaid mode.

When acquiring the prepaid key, the management device 70 extracts the available usage from the prepaid key. The management device 70 assigns the extracted available usage to each of the plural image processing apparatuses 60. Here, it is assumed that the plural image processing apparatuses 60 include an image processing apparatus 60-1, an image processing apparatus 60-2 and an image processing apparatus 60-3.

For example, when the available usage is 6000, the management device 70 assigns an available usage “1000” to the image processing apparatus 60-1, an available usage “2000” to the image processing apparatus 60-2, and an available usage “3000” to the image processing apparatus 60-3. The management device 70 transmits the available usage “1000” to the image processing apparatus 60-1, the available usage “2000” to the image processing apparatus 60-2, and the available usage “3000” to the image processing apparatus 60-3, together with the ratio parameter 251 included in the prepaid key. Each of the image processing apparatuses 60-1 to 60-3 stores the available usage and the ratio parameter 251 received from the management device 70 in the storage unit 66. As in the above-described embodiment, the image processing apparatuses 60-1 to 60-3 count the usage and restricts execution of a process by the processing unit 601 according to the relationship between the counted usage and the available usage stored in the storage unit 66.

As another example, the management device 70 may restrict the operation of the plural image processing apparatuses 60 according to the usage. In this case, the management device 70 has the same functions as the counting unit 604 and the restricting unit 605 described above. The following process performed by the management device 70 is implemented, for example, by a processor executing a program stored in a memory.

The management device 70 counts the usage of each image processing apparatus 60. The management device 70 restricts the operation of the image processing apparatus 60 according to the relationship between the counted usage and an assigned available usage. For example, when the usage of the image processing apparatus 60-1 is 1000 or less, the management device 70 permits the image processing apparatus 60-1 to execute a process. When the usage of the image processing apparatus 60-1 exceeds 1000, the management device 70 prohibits the image processing apparatus 60-1 from executing a process.

Specifically, before executing the process, the image processing apparatus 60-1 inquires the management device 70 about whether or not to execute. The management device 70 determines whether or not the usage of the image processing apparatus 60-1 exceeds the available usage. When the usage of the image processing apparatus 60-1 is equal to or less than the available usage, the management device 70 transmits a response permitting execution of the process to the image processing apparatus 60-1. Upon receiving this response, the image processing apparatus 60-1 executes the process. Meanwhile, when the usage of the image processing apparatus 60-1 exceeds the available usage, the management device 70 transmits a response prohibiting execution of the process to the image processing apparatus 60-1. Upon receiving this response, the image processing apparatus 60-1 does not execute the process. According to this modification, it is possible to divide and use a set available usage on plural image processing apparatuses 60.

In this modification, the way to assign the usage is not limited to the above-described method. For example, when the available usage is 6000 and the total usage of the image processing apparatuses 60-1 to 60-3 is 6000 or less, execution of the process in each of the image processing apparatuses 60-1 to 60-3 may be permitted. In this case, when the total usage of the image processing apparatuses 60-1 to 60-3 exceeds 6000, execution of the process in each of the image processing apparatuses 60-1 to 60-3 is prohibited.

### Modification 6

In the above-described embodiment, use of the image processing apparatus 60 may be restricted for each user or each place of employment to which the user belongs. In this case, before the user uses the image processing apparatus 60, user authentication is performed using, for example, a user ID and a password. A user who uses the image processing apparatus 60 or a place of employment to which the user belongs is identified by this user authentication.

In this case, the image processing apparatus 60 functions as an assigning unit, in addition to the processing unit 601, the acquisition unit 602, the transition unit 603, the counting unit 604 and the restricting unit 605 illustrated in FIG. 5. The assigning unit is implemented, for example, by the processor 61 executing a program stored in the memory 62. The assigning unit assigns the available usage for each user or each user's place of employment. For example, when the available usage is 1000, the available usage of 100 may be assigned to each of ten users.

The counting unit 604 counts the usage of the image processing apparatus 60 for each user or each user's place of employment. The restricting unit 605 restricts execution of a process by the processing unit 601 according to the relationship between the counted usage and an assigned available usage. Here, it is assumed that the available usage “100” is assigned to a user X. In this case, when the usage of the user X is 100 or less, the restricting unit 605 permits the execution of a process by the user X. When the usage of the user X exceeds 100, the restricting unit 605 prohibits the execution of the process by the user X. The restriction according to this modification may be performed by the above-described management device 70.

### Modification 7

In the above-described embodiment, the image processing apparatus 60 may output the ratio parameter 251 stored in the storage unit 66. Specifically, the ratio parameter 251 may be displayed on the display 64. In another example, the ratio parameter 251 may be printed by the image forming unit 67. In another example, the ratio parameter 251 may be transmitted to another device via the communication interface 63.

### Modification 8

An entity that implements the functions of the control system 1 is not limited to the example described in the exemplary embodiment. For example, the functions of the issuing devices 10 and 20 may be implemented by a single issuing device. Further, a part of the functions of the issuing device 10, the issuing device 20 or the image processing apparatus 60 may be implemented by other devices.

### Modification 9

The steps of the process performed in the control system are not limited to the example described in the above-described embodiment. The steps of this process may be interchanged unless contradictory. The present invention may be provided as a control method including steps of a process performed in the control system 1.

### Modification 10

The present invention may be provided as a program executed by the processor 11, 21 or 61. This program may be downloaded via a communication line such as the Internet. In addition, this program may be provided in a form recorded in a computer-readable recording medium such as a magnetic recording medium (a magnetic tape, a magnetic disk, etc.), an optical recording medium (an optical disc, etc.), a magneto-optical recording medium, a semiconductor memory or the like.

### Modification 11

At least two of the transition key, the prepaid key including the available usage, the prepaid key including the ratio parameter and the prepaid key including the release key may be encrypted by different encryption schemes or different encryption keys. In this case, the image processing apparatus 60 decrypts at least two of the transition keys, the prepaid key including the available usage, the prepaid key including the ratio parameter and the prepaid key including the release key by different encryption schemes or different encryption keys. Accordingly, even a provider who may create one of these keys may not create the other keys. For example, even a provider who is able to create the prepaid key including the available usage may not create the prepaid key including the release key, thereby improving security.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
a processing unit that executes a process related to an image;
an acquisition unit that acquires a first key and a second key including a restriction condition;
a transition unit that transitions from a first operation mode to a second operation mode when the first key is acquired;
a counting unit that counts usage of the processing unit; and
a restricting unit that restricts execution of the process by the processing unit in the second operation mode according to a relationship between the counted usage and the restriction condition included in the acquired second key.

2. The image processing apparatus according to claim 1, wherein
the restriction condition includes available usage, and
the restricting unit restricts the execution of the process by the processing unit according to a relationship between (i) a sum of the counted usage and (ii) the available usage included in the acquired second key.

3. The image processing apparatus according to claim 2, wherein the restricting unit permits the execution of the process by the processing unit when the sum of the usage is equal to or less than the available usage.

4. The image processing apparatus according to claim 2, wherein the restricting unit prohibits the execution of the process by the processing unit when the sum of the usage exceeds the available usage.

5. The image processing apparatus according to claim 1, wherein
the acquisition unit acquires a third key,
the transition unit transitions from the second operation mode to the first operation mode when the third key is acquired, and
the restricting unit permits the execution of the process by the processing unit in the first operation mode with no restriction on the usage.

6. The image processing apparatus according to claim 5, wherein at least two of the first key, the second key and the third key are decrypted by different encryption schemes or different encryption keys.

7. The image processing apparatus according to claim 1, wherein
the restriction condition includes a parameter having a ratio of a plurality of usages which are determined in advance for a plurality of process conditions,
the processing unit executes the process according to a set process condition, and
the counting unit counts the usage corresponding to the process according to a ratio, that the parameter has, corresponding to the set process condition.

8. The image processing apparatus according to claim 1, wherein
the processing unit executes an image forming process using a toner,
the second key includes a specific toner type, and
the restricting unit prohibits execution of the image forming process by the processing unit when a type of the toner used in the image forming process is different from the specific toner type.

9. A control system comprising:
a first issuing unit that issues a first key;
a second issuing unit that issues a second key including a restriction condition;
a processing unit that performs a process related to an image;
an acquisition unit that acquires the issued first key and the issued second key;
a transition unit that changes an operation mode of an image processing apparatus from a first operation mode to a second operation mode when the first key is acquired;
a counting unit that counts usage of the processing unit; and
a restricting unit that restricts execution of the process by the processing unit in the second operation mode according to a relationship between the counted usage and the restriction condition included in the acquired second key.

10. The control system according to claim 9, further comprising:
an issuing device including the second issuing unit, wherein
the first issuing unit issues the first key to a terminal device,
the issuing device permits an access from the terminal device in response to the issuance of the first key, and
the terminal device accesses the issuing device to acquire the issued second key and outputs the acquired second key to the processing unit.

11. A non-transitory computer readable storage medium storing a program that causes a computer to execute image processing comprising:
acquiring a first key and a second key including a restriction condition;
transitioning from a first operation mode to a second operation mode when the first key is acquired;
counting usage of a processing unit that executes a process related to an image; and
restricting execution of the process by the processing unit in the second operation mode according to a relationship between the counted usage and the restriction condition included in the acquired second key.
